(19) United States
(12) Patent Application Publication
(10) Pub. No.: US 2009/0321506 A1
(43) Pub. Date: Dec. 31, 2009

(54) STRUCTURES FOR SECURING CONTAINERS

(75) Inventors: Richard Minton, Cheshire, CT (US); Steven T. Stuhmer, Pine Bush, NY (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Rand Whitney Group, LLC, Worcester, MA (US)

(21) Appl. No.: 12/186,031

(22) Filed: Aug. 5, 2008

Related U.S. Application Data
(63) Continuation-in-part of application No. 12/164,728, filed on Jun. 30, 2008, now abandoned.

(51) Int. Cl. B26D 5/42

(52) U.S. Cl. 229/198.3

(57) ABSTRACT

Disclosed herein are improvements to fold-over structures in containers comprising two leaves foldably connected to each other along a folding line and a flap sandwiched by the two leaves when they fold together. A slot can be cut along the folding line and the flap can have an extension that is insertable into the slot to prevent the lateral movement of the flap along the long axis of the slot. One leaf can have a locking tab insertable into a slit cut in the container when the two leaves fold together in spaced parallelism to each other. An outer edge of the locking tab can extend beyond the corresponding end of the slit to secure the locking tab once inserted into the slit. The container can have a hand hole cut through both leaves and in alignment with the flap at least along the upper edge of the hand hole.

### RELATED APPLICATION

This application is a continuation-in-part of U.S. application Ser. No. 12/164,728, filed Jun. 30, 2008. The entire teachings of the above application is incorporated herein by reference.

### BACKGROUND OF THE INVENTION

Containers exist in many forms, e.g., cartons, boxes, crates, cans, buckets, trays, etc. The United States Postal Service (USPS) currently uses a polyethylene letter tray in its Processing and Distribution Centers nationwide to convey sorted letter mail. This tray, while having been an effective product for years, is now viewed as costly to replace, a source of great leakage from their system (e.g., people take them home for personal use), and difficult to recycle. Prior to the plastic trays, the USPS used corrugated letter trays to convey sorted letter mail. One of the reasons that the corrugated trays were replaced by the plastic trays was that the corrugated paper trays were not as durable as the plastic trays. There is a need for a container that is durable, cost-efficient to produce or replace, and recyclable.

### SUMMARY OF THE INVENTION

The present invention relates to structures for securing containers. The structures disclosed in the present invention, when embodied in containers, can increase the durability of the containers while keeping the containers cost-efficient to produce or replace, and/or recyclable.

A container can be produced from a blank. The blank can comprise a central wall, sides and end elements foldable therefrom. The sides can have end flaps foldable therefrom. Each end element can have at least one or more transverse scores to define two leaves and permit one fold-over leaf to fold over the end flaps and in spaced parallelism to the other leaf. The fold-over leaf can have one or more locking tabs at the end thereof. Each of the locking tabs can be insertable into a slit cut in the blank when the fold-over leaf is folded over the end flaps in spaced parallelism to the other leaf. The slit can be cut in the central wall. The container can have holes cut through both the fold-over leaf and the other leaf. The holes can align with each other and form a hand hole when the fold-over leaf is folded over the end flaps in spaced parallelism to the other leaf. The end flaps can have cut outs that are in alignment with the hand hole at least along the upper edge of the hand hole when the fold-over leaf is folded over the end flaps in spaced parallelism to the other leaf.

According to one embodiment of the present invention, for a given end element, a slot can be cut in the end element near or bordering one or more of the transverse scores of the end element. The long axis of the slot can be parallel to the one or more of the transverse scores. One or more of the end flaps can have an extension. The extension can be insertable into one of the slots when the fold-over leaf is folded over the end flaps, to prevent an outward lateral movement of the end flap along the long axis of the slot with respect to the container. The extension can be located at least partially above the hand hole when the fold-over leaf is folded over the end flaps in spaced parallelism to the other leaf. Two or more extensions may be inserted into one slot side by side along the long axis of the slot.

According to another embodiment of the present invention, for a given locking tab inserted into a given slit, an outer edge of the locking tab can extend beyond the corresponding end of the slit to secure the locking tab in the slit once inserted. The locking tab can be snap inserted into the slit. Alternatively, the locking tab can be inserted into the slit by slightly bending or twisting the locking tab.

According to still another embodiment of the present invention, the two features each described in the two embodiments above, respectively, can both be included in one container.

The blank can be made of corrugated paper. The paper can be recyclable. The paper can be coated with moisture-resistant coating. The moisture-resistant coating may be repulpable.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of a corrugated paper letter tray that was previously used by the USPS.

FIG. 2 is a top view of a blank of foldable sheet material constructed to produce the corrugated paper letter tray as shown in FIG. 1.

FIG. 3 is a perspective view of a corrugated paper letter tray according to an embodiment of the present invention.

FIG. 4A is a top view of part of a blank of foldable sheet material showing a locking tab present in a corrugated paper letter tray that was previously used by USPS.

FIG. 4B is a top view of part of a blank of foldable sheet material showing a locking tab according to the present invention.

FIG. 5 is a top view of a blank of foldable sheet material constructed to produce a corrugated paper letter tray according to the embodiment shown in FIG. 3.

FIG. 6 is a perspective view of a corrugated paper letter tray according to another embodiment of the present invention.

FIG. 7 is a top view of a blank of foldable sheet material constructed to produce a corrugated paper letter tray according to the embodiment shown in FIG. 6.

### DETAILED DESCRIPTION OF THE INVENTION

A description of example embodiments of the invention follows.

The present invention relates to structures for securing containers.

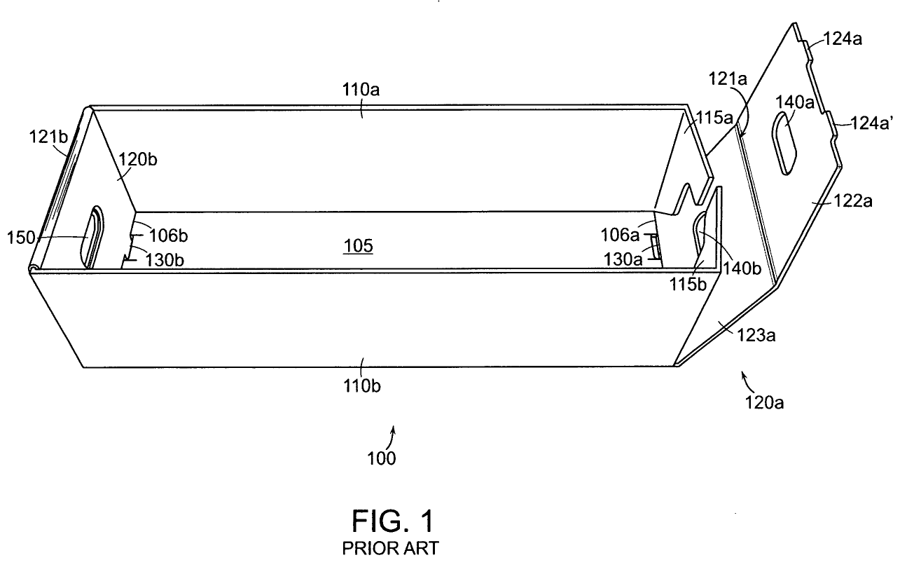

FIG. 1 is a perspective view of a corrugated paper letter tray that was previously used by the USPS. The assembled tray 100 has a bottom 105, two sides 110a and 110b, and two folded end elements 120a and 120b. One end element 120a is partially unfolded to show the structures it comprises. Each side has two end flaps folded therefrom. Only one end flap of each side is shown in FIG. 1 (end flap 115a folded from side 110a and end flap 115b folded from side 110b). Each end element folds from the bottom along a folding line (shown in FIG. 1 as 106a and 106b for end elements 120a and 120b, respectively) and has a pair of parallel transverse scores close to each other (each pair shown in FIG. 1 as 121a and 121b for end elements 120a and 120b, respectively) to define two leaves (shown in FIG. 1 as 122a and 123a for end element 120a) and permit one fold-over leaf 122a to fold over the end flaps 115a and 115b and in spaced parallelism to the other leaf 123a when the letter tray 100 is assembled. A hole 140a is cut in fold-over leaf 122a. A hole 140b is cut in the other leaf 123a. When fold-over leaf 122a is folded over the end flaps 115a and 115b in spaced parallelism to the other leaf 123a, hole 140a and hole 140b together form a hand hole in registration with each other for providing an easy means to lift and carry the container. The end flaps 115a and 115b sandwiched in between the fold-over leaf 122a and the other leaf 123a each have a cut out that is in registration with the hand hole at least along the upper edge of the hand hole formed by holes 140a and 140b when the fold-over leaf 122a is folded over end flaps 115a and 115b in spaced parallelism with the other leaf 123a. A hand hole after end element 120b is assembled is shown as 150 in FIG. 1.

Four slits are cut in the bottom 105, two of which borders end element folding line 106a (only one is shown in FIG. 1 as 130a), and the other two of which borders end element folding line 106b (only one is shown in FIG. 1 as 130b). The long axis of each of these slits is parallel to the end element folding line each borders, respectively. Each fold-over leaf has two locking tabs at the end thereof (shown in FIG. 1 as 124a and 124a′ for fold-over leaf 122a). When fold-over leaf 122a is folded over end flaps 115a and 115b and in spaced parallelism to the other leaf 123a to assemble the tray 100, the locking tabs can be inserted into the slits to secure the end elements into place (see assembled end element 120b in FIG. 1).

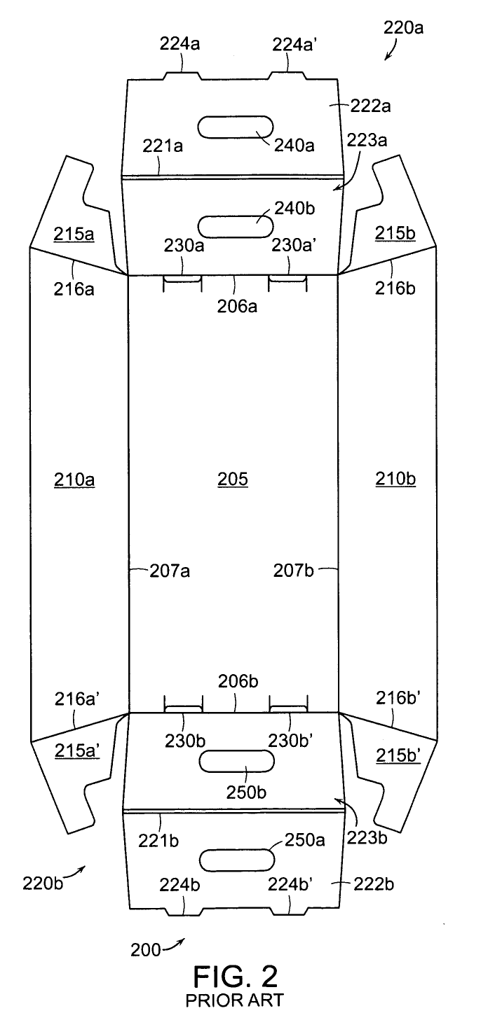

FIG. 2 is a top view of a blank of foldable sheet material constructed to produce the corrugated paper letter tray as shown in FIG. 1. The blank 200 comprises a central wall 205, two sides 210a and 210b, and two end elements 220a and 220b. The two sides 210a and 210b are each foldable from the central wall 205 along a folding line (207a and 207b, respectively). The two end elements 220a and 220b are each foldable from the central wall 205 along a folding line (206a and 206b, respectively). Side 210a has two end flaps 215a and 215a′, each foldable therefrom along a folding line (216a and 216a′, respectively). Side 210b has two end flaps 215b and 215b′, each foldable therefrom along a folding line (216b and 216b′, respectively). End element 220a has a set 221a of two parallel transverse scores to define two leaves 222a and 223a and permit one fold-over leaf 222a to fold over end flaps 215a and 215b and in spaced parallelism to the other leaf 223a. End element 220b has a pair 221b of parallel transverse scores close to each other to define two leaves 222b and 223b and permit one fold-over leaf 222b to fold over end flaps 215a′ and 215b′ and in spaced parallelism to the other leaf 223b.

A hole 240a is cut in fold-over leaf 222a. A hole 240b is cut in the other leaf 223a. When fold-over leaf 222a is folded over the end flaps 215a and 215b in spaced parallelism to the other leaf 223a, hole 240a and hole 240b together form a hand hole in registration with each other for providing an easy means to lift and carry the container. Similarly, at the other end of the blank, a hole 250a is cut in fold-over leaf 222b. A hole 250b is cut in the other leaf 223b. When fold-over leaf 222b is folded over the end flaps 215a′ and 215b′ in spaced parallelism to the other leaf 223b, hole 250a and hole 250b together form a hand hole in registration with each other for providing an easy means to lift and carry the container.

Four slits are cut in the central wall 205. Two of them 230a and 230a′ border folding line 206a. The other two 230b and 230b′ border folding line 206b. The long axis of each of the four slits is parallel to the folding line each of them borders, respectively. Fold-over leaf 222a has two locking tabs 224a and 224a′ at its end. Fold-over leaf 222b has two locking tabs 224b and 224b′ at its end. When the fold-over leaf 222a is folded over the end flaps 215a and 215b in spaced parallelism to the other leaf 223a, each of the locking tabs 224a and 224a′ can be inserted into slits 230a and 230a′, respectively. When the fold-over leaf 222b is folded over the end flaps 215a′ and 215b′ in spaced parallelism to the other leaf 223b, each of the locking tabs 224b and 224b′ can be inserted into slits 230b and 230b′, respectively. When both fold-over leaves 222a and 222b are folded over their respective pair of end flaps (215a and 215b, and 215a′ and 215b′, respectively), and all locking tabs 224a, 224a′, 224b and 224b′ are inserted into the slits 230a, 230a′, 230b and 230b′, respectively, the corrugated paper letter tray of FIG. 1 is produced.

For use by the USPT as a corrugated paper letter tray, the thus produced container suffered from several shortcomings. Due to insufficient friction provided by the two leaves of an end element sandwiching an end flap, the end flaps can be pulled out during normal handling conditions by applying forces on the sides in a outward direction with respect to the tray. In addition, due to extended use, the locking tabs on the fold-over leaves can be lifted up and out of the slits, resulting in the unfolding of the end elements, as shown for end element 120a in FIG. 1. To overcome these shortcomings, USPS had been inserting metal rivets in the folded ends of the trays to secure the ends, thereby preventing the folded ends from accidentally falling apart (being unfolded).

For a while, USPS changed to using letter trays made of polyethylene. While more durable than the corrugated letter trays, these plastic letter trays are more costly to produce and more difficult to recycle, adding burdens both financially and environmentally.

The present inventor recognized the problems associated with the above mentioned letter trays, and discloses herein a corrugated letter tray that is substantially more durable than the non-riveted corrugated letter tray described above, and yet costs less than the plastic letter trays, while being recyclable.

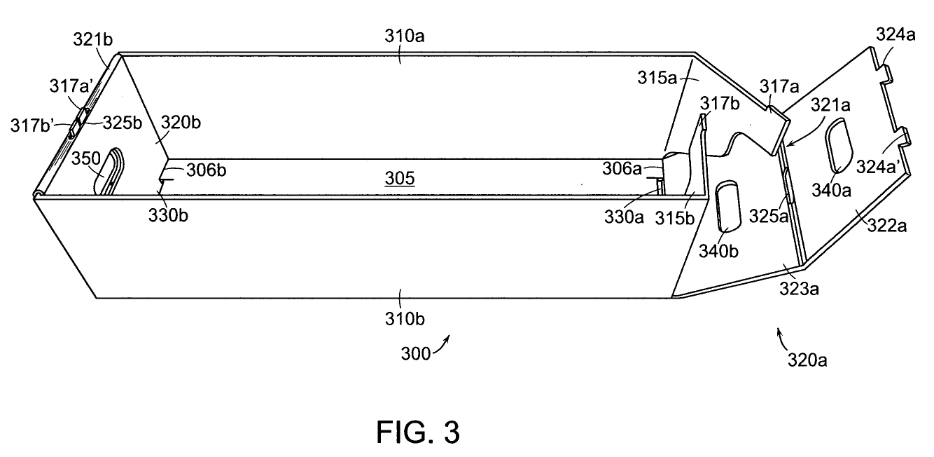

FIG. 3 is a perspective view of an embodiment of the corrugated paper letter trays according to the present invention. The assembled tray 300 has a bottom 305, two sides 310a and 310b, and two folded end elements 320a and 320b. One end element 320a is partially unfolded to show the structures it comprises. Each side has two end flaps folded therefrom. Only one end flap of each side is shown in FIG. 3 (end flap 315a folded from side 310a and end flap 315b folded from side 310b). Each end element folds from the bottom along a folding line (shown in FIG. 3 as 306a and 306b for end elements 320a and 320b, respectively) and has a pair of parallel transverse scores close to each other (each pair shown in FIG. 3 as 321a and 321b for end elements 320a and 320b, respectively) to define two leaves (shown in FIG. 3 as 322a and 323a for end element 320a) and permit one fold-over leaf 322a to fold over the end flaps 315a and 315b and in spaced parallelism to the other leaf 323a, when the letter tray 300 is assembled. A hole 340a is cut in fold-over leaf 322a. A hole 340b is cut in the other leaf 323a. When fold-over leaf 322a is folded over the end flaps 315a and 315b in spaced parallelism to the other leaf 323a, hole 340a and hole 340b together form a hand hole in registration with each other for providing an easy means to lift and carry the container. The end flaps 315a and 315b sandwiched in between the fold-over leaf 322a and the other leaf 323a each have a cut out that is in registration with the hand hole at least along the upper edge of the hand hole formed by holes 340a and 340b when the fold-over leaf 322a is folded over end flaps 315a and 315b in spaced parallelism with the other leaf 323a. A hand hole after end element 320b is assembled is shown as 350 in FIG. 3.

Four slits are cut in the bottom 305, two of which border end element folding line 306a (only one is shown in FIG. 3 as 330a), and the other two of which border end element folding line 306b (only one is shown in FIG. 3 as 330b). The long axis of each of these slits is parallel to the end element folding line each borders, respectively. Each fold-over leaf has two locking tabs at the end thereof (shown in FIG. 3 as 324a and 324a′ for fold-over leaf 322a). When fold-over leaf 322a is folded over end flaps 315a and 315b and in spaced parallelism to the other leaf 323a to assemble the tray 300, the locking tabs can be inserted into the slits to secure the end elements into place (see assembled end element 320b in FIG. 3).

The corrugated letter tray according to the present invention has a slot cut in each of the end elements 320a and 320b (shown in FIG. 3 as 325a and 325b, respectively). The slots 325a and 325b are each cut between the pair of transverse parallel scores 321a and 321b, respectively. The long axis of the slots are parallel to the scores they border, respectively, so that when the two leaves of an end element are folded in spaced parallelism to each other, the slots are on the edge of the folded elements (see 325b in FIG. 3). As shown, each slot borders one or both of a pair of transverse parallel scores along its long axis. However, a slot does not have to border any of the scores, as long as it is cut between a pair of scores and its long axis is parallel to those scores. Each of the end flaps 315a and 315b have an extension (shown in FIG. 3 as 317a and 317b, respectively) configured to be insertable into slot 325a when fold-over leaf 322a fold over the end flaps 315a and 315b in spaced parallelism to the other leaf 323a. As shown for end element 320b in FIG. 3, two extensions 317a′ and 317b′ of their respective end flaps (not shown) are inserted into the same slot 325b.

The number of slots in the end elements and the number of extensions on the end flaps are not limited to those shown in FIG. 3. An end flap may have more than one extension. An end element may have more than one slot. A slot may accommodate only one extension or, as shown in FIG. 3, more than one extensions. The purpose of the slot/extension combination structure is to prevent lateral movements, particularly outward lateral movements of the end flaps when the end flaps are sandwiched by the fold-over leaves and the other leaves of the end elements (e.g., to prevent the sides from being accidentally pulled out sideways). Therefore, as long as the lateral movements of the extensions inserted into the slots, in one or both directions along the long axis of the slots, are prevented, the width of the extensions and the length of the long axis of the slots can vary considerably. In the case as shown in FIG. 3, when one slot accommodates more than one extension from different end flaps, the width of the slot can be configured to be the total length of the extensions inserted therein side by side. Preferably, each extension is located at least partially above the hand hole when the fold-over leaf is folded over the end flaps in spaced parallelism to the other leaf. More preferably, as shown for assembled end element 320b in FIG. 3, each extension (317a′ and 317b′) is located completely above the hand hole 350 when the fold-over leaf is folded over the end flaps in spaced parallelism to the other leaf. Because each of the end flaps to which extensions 317a′ and 317b′ are connected have a cut out that is in registration with the hand hole 350 at least along the upper edge of the hand hole 350 when end element 320b is assembled, any upward force exerted on the upper edge of hand hole 350, when a hand is inserted into the hand hole to lift the container, is also applied to those end flaps. Having the extensions 317a′ and 317b′ above hand hole 350 ensures that extensions 317a′ and 317b′ are pushed upward when the container is being lifted, further securing the extensions 317a′ and 317b′ in place in slot 325b.

An advantage to having the slots and the extensions at or close to the center of the edge of an assembled end element is the long length of cardboard in the fold of the end element outside of the extensions. The sides are frequently being pushed outward by the contents of the letter tray during use, and the extended length of cardboard resists outward movement of the extensions and reduces the likelihood of tearing.

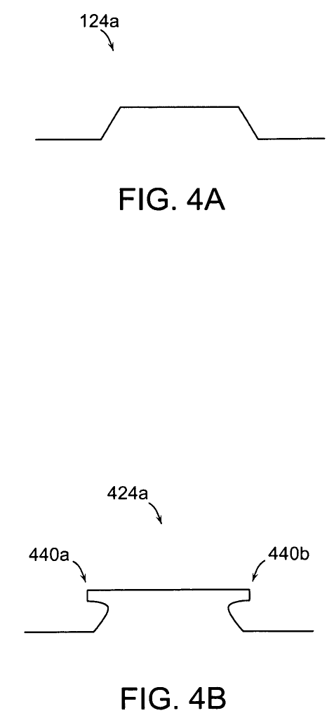

Notably, compared to FIG. 1, the locking tabs of FIG. 3 (324a and 324a′) each have “wings” to the end thereof (shown in FIG. 4B as wings 440a and 440b at the end of locking tab 424a), effectively adding to the width of the end of the unmodified locking tab (shown as 124a in FIG. 4A). This modified configuration can provide additional locking security once the locking tabs are inserted into the slits. The modification is not limited to the structure as shown in FIG. 4B. As long as at least one side of the end of a locking tab goes beyond the respective end of a slit once the locking tab is inserted into the slit in its natural position, so that the locking tab cannot be pulled out of the slit under normal use conditions, the locking tab is considered to be securely engaged in the slit. For example, the width of the end of the locking tabs can slightly exceed the long axis of the slits, so that the locking tabs can be inserted into the slits with relative ease, e.g., by snap fit. Alternatively, the locking tabs may be slightly bent or twisted at their ends for the locking tabs to be inserted into the slits, as long as the slits can allow the insertion of the locking tabs with bent or twisted ends. Once inserted, the locking tabs can assume their shapes prior to the insertion, either automatically upon releasing of the bending or twisting (due to the elasticity of the material used) or manually (by reversing the bending or twisting).

Together, the extensions from the end flaps into the slots of the end elements and the modified locking tabs allow for elimination of the rivets used in prior letter trays, thus reducing cost, easing assembly and improving case of recycling. The rivets prevented outward sliding of the end flaps and lifting of the fold-over leaf, functions now provided by the cardboard extensions and the improved locking tabs.

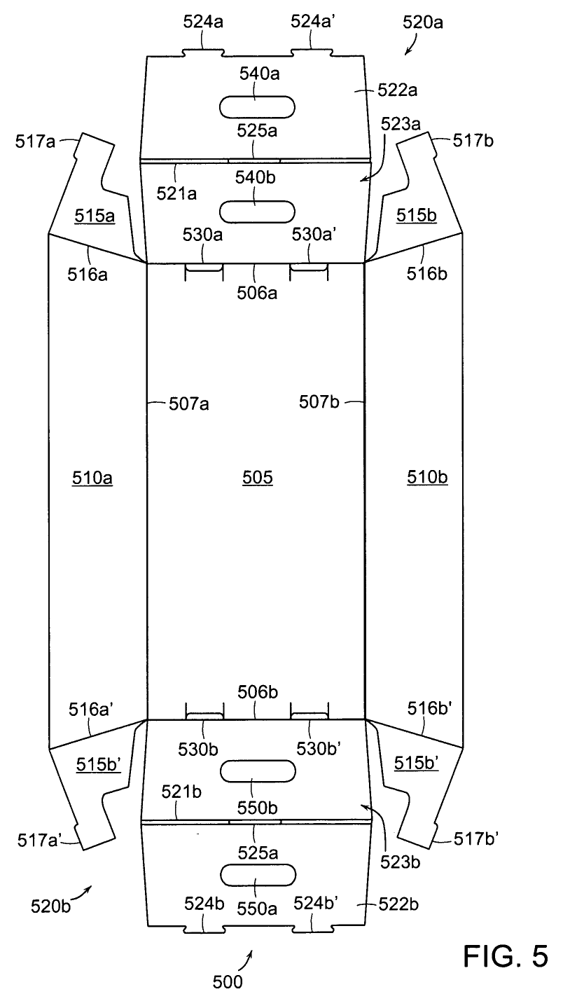

FIG. 5 is a top view of a blank of foldable sheet material constructed to produce a corrugated paper letter tray according to the present invention as shown in FIG. 3. The blank 500 comprises a central wall 505, two sides 510a and 510b, and two end elements 520a and 520b. The two sides 510a and 510b are each foldable from the central wall 505 along a folding line (507a and 507b, respectively). The two end elements 520a and 520b are each foldable from the central wall 505 along a folding line (506a and 506b, respectively). Side 510a has two end flaps 515a and 515a′, each foldable therefrom along a folding line (516a and 516a′, respectively). Side 510b has two end flaps 515b and 515b′, each foldable therefrom along a folding line (516b and 516b′, respectively). End element 520a has a pair 521a of parallel transverse scores to define two leaves 522a and 523a and permit one fold-over leaf 522a to fold over end flaps 515a and 515b and in spaced parallelism to the other leaf 523a. End element 520b has a pair 521b of parallel transverse scores to define two leaves 522b and 523b and permit one fold-over leaf 522b to fold over end flaps 515a′ and 515b′ and in spaced parallelism to the other leaf 523b.

A hole 540a is cut in fold-over leaf 522a. A hole 540b is cut in the other leaf 523a. When fold-over leaf 522a is folded over the end flaps 515a and 515b in spaced parallelism to the other leaf 523a, hole 540a and hole 540b together form a hand hole in registration with each other for providing an easy means to lift and carry the container. Similarly, at the other end of the blank, a hole 550a is cut in fold-over leaf 522b. A hole 550b is cut in the other leaf 523b. When fold-over leaf 522b is folded over the end flaps 515a′ and 515b′ in spaced parallelism to the other leaf 523b, hole 550a and hole 550b together form a hand hole in registration with each other for providing an easy means to lift and carry the container.

Four slits are cut in the central wall 505. Two of them 530a and 530a′ border folding line 506a. The other two 530b and 530b′ border folding line 506b. The long axis of each of the four slits is parallel to the folding line each of them borders, respectively. Fold-over leaf 522a has two locking tabs 524a and 524a′ at its end. Fold-over leaf 522b has two locking tabs 524b and 524b′ at its end. When the fold-over leaf 522a is folded over the end flaps 515a and 515b in spaced parallelism to the other leaf 523a, each of the locking tabs 524a and 524a′ can be inserted into slits 530a and 530a′, respectively. When the fold-over leaf 522b is folded over the end flaps 515a′ and 515b′ in spaced parallelism to the other leaf 523b, each of the locking tabs 524b and 524b′ can be inserted into slits 530b and 530b′, respectively.

A slot 525a is cut in end element 520a. Slot 525a is cut between the pair 521a of scores and borders the scores along its long axis. A slot 525b is cut in end element 520b. Slot 525b is cut between the pair 521b of scores and borders the scores along its long axis. End flaps 515a, 515b, 515a′ and 515b′ each have an extension 516a, 516b, 516a′ and 516b′, respectively. The extensions 516a and 516b can be inserted into slot 525a when fold-over leaf 522a folds over end flaps 515a and 515b in spaced parallelism to the other leaf 523b. The extensions 516a′ and 516b′ can be inserted into slot 525b when fold-over leaf 522b folds over end flaps 515a′ and 515b′ in spaced parallelism to the other leaf 523b.

When both fold-over leaves 522a and 522b are folded over their respective pair of end flaps (515a and 515b, and 515a′ and 515b′, respectively), all locking tabs 524a, 524a′, 524b and 524b′ are inserted into the slits 530a, 530a′, 530b and 530b′, respectively, extensions 516a and 516b are inserted into slot 525a, and extensions 516a′ and 516b′ are inserted into slot 525b, the corrugated paper letter tray of FIG. 3 is produced. It is noticeable in FIG. 5 that the end of each of the locking tabs 524a, 524a′, 524b and 524b′ is wider than the base of the locking tabs connected to their respective fold-over leaves. FIG. 4B shows a blown-up view of one of these locking tabs to show the “wing” structure in detail.

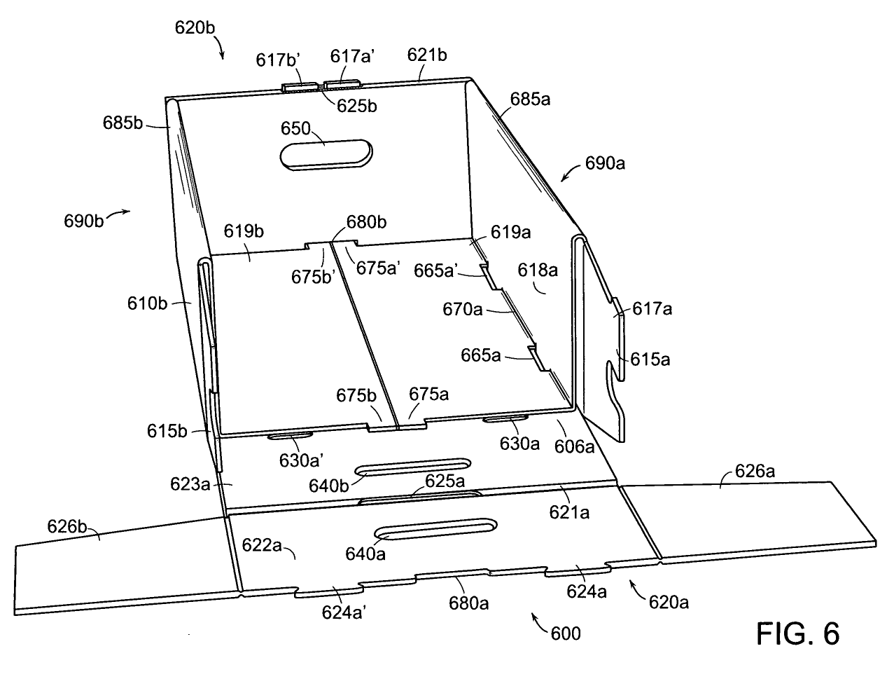

FIG. 6 is a perspective view of another embodiment of the corrugated paper letter trays according to the present invention. The assembled tray 600 has a bottom, two folded side elements 690a and 690b, and two folded end elements 620a and 620b. One end element 620a is partially unfolded to show the structures it comprises. Each side element folds from the bottom and comprises three leaves—an outer leaf, an inner leaf, and a bottom leaf. The outer leaf folds from the bottom along a folding line and forms an outer wall of the side. The inner leaf folds over the side leaf inwardly along a pair of parallel transverse scores close to each other (each pair shown in FIG. 6 as 685a and 685b for side elements 690a and 690b, respectively) and forms an inner wall of the side when folded in spaced parallelism to the outer leaf. The bottom leaf folds from the inner leaf along a folding line (shown in FIG. 6 as 670a connecting inner leaf 618a and bottom leaf 619a) and in spaced parallelism to the bottom. Each outer leaf has two end flaps folded therefrom. Visible for side element 690a on the right of FIG. 6 are inner leaf 618a, bottom leaf 619a and end flap 615a folded from the outer leaf (not visible). Two slots are cut along the folding line connecting the bottom and the outer leaf (not shown). Two slotted tabs 665a and 665a′ are cut along the folding line 670a connecting inner leaf 618a and bottom leaf 619a. When the inner leaf is folded over the outer leaf in spaced parallelism thereto, the slotted tabs 665a and 665a′ cooperate and lock into the slots cut along the folding line connecting the bottom and the outer leaf. Visible for side element 690b on the left of FIG. 6 are outer leaf 610b and the end tab 615b foldably connected therefrom. Each end element folds from the bottom along a folding line (shown in FIG. 6 as 606a connecting the bottom and end element 620a) and has a pair of parallel transverse scores close to each other (each pair shown in FIG. 6 as 621a and 621b for end elements 620a and 620b, respectively) to define two leaves (shown in FIG. 6 as 622a and 623a for end element 620a) and permit one fold-over leaf 622a to fold over the end flaps 615a and 615b and in spaced parallelism to the other leaf 623a, when the letter tray 600 is assembled.

A hole 640a is cut in fold-over leaf 622a. A hole 640b is cut in the other leaf 623a. When fold-over leaf 622a is folded over the end flaps 615a and 615b in spaced parallelism to the other leaf 623a, hole 640a and hole 640b together form a hand hole in registration with each other for providing an easy means to lift and carry the container. The end flaps 615a and 615b sandwiched in between the fold-over leaf 622a and the other leaf 623a each have a cut out that is in registration with the hand hole along the edge of the hand hole formed by holes 640a and 640b when the fold-over leaf 622a is folded over end flaps 615a and 615b in spaced parallelism with the other leaf 623a. A hand hole after end element 620b is assembled is shown as 650 in FIG. 6. Each fold-over leaf has two side flaps foldably connected thereto (shown in FIG. 6 as side flaps 626a and 626b foldably connected to fold-over leaf 622a). When a fold-over leaf is folded over in spaced parallelism to the other leaf, a side flap can be inserted into the space between the outer leaf and the inner leaf at the corresponding side, so that when the container is assembled, the side flap is sandwiched between the outer leaf and the inner leaf in spaced parallelism to both the outer leaf and the inner leaf.

Four slits are cut in the bottom, two of which 630a and 630a′ border end element folding line 606a, and the other two of which border the other end element folding line (not shown in FIG. 6). The long axis of each of these slits is parallel to the end element folding line each borders, respectively. Each fold-over leaf has two locking tabs at the end thereof (shown in FIG. 6 as 624a and 624a′ for fold-over leaf 622a). When fold-over leaf 622a is folded over end flaps 615a and 615b and in spaced parallelism to the other leaf 623a to assemble the tray 600, the locking tabs can be inserted into the slits to secure the end elements into place (see assembled end element 620b in FIG. 6).

The corrugated letter tray according to the present invention has a slot cut in each of the end elements 620a and 620b (shown in FIG. 6 as 625a and 625b, respectively). The slots 625a and 625b are each cut between the pair of transverse parallel scores 621a and 621b, respectively. The long axis of the slots are parallel to the scores they border, respectively, so that when the two leaves of an end element are folded in spaced parallelism to each other, the slots are on the edge of the folded elements (see 625b in FIG. 6). As shown, each slot borders one or both of a pair of transverse parallel scores along its long axis. However, a slot does not have to border any of the scores, as long as it is cut between a pair of scores and its long axis is parallel to those scores. Each of the end flaps 615a and 615b have an extension (shown in FIG. 6 as 617a for end flap 615a) configured to be insertable into slot 625a when fold-over leaf 622a fold over the end flaps 615a and 615b in spaced parallelism to the other leaf 623a. As shown for end element 620b in FIG. 6, two extensions 617a′ and 617b′ of their respective end flaps (not shown) are inserted into the same slot 625b.

The number of slots in the end elements and the number of extensions on the end flaps are not limited to those shown in FIG. 6. An end flap may have more than one extension. An end element may have more than one slot. A slot may accommodate only one extension or, as shown in FIG. 6, more than one extensions. The purpose of the slot/extension combination structure is to prevent lateral movements, particularly outward lateral movements of the end flaps when the end flaps are sandwiched by the fold-over leaves and the other leaves of the end elements (e.g., to prevent the sides from being accidentally pulled out sideways). Therefore, as long as the lateral movements of the extensions inserted into the slots, in one or both directions along the long axis of the slots, are prevented, the width of the extensions and the length of the long axis of the slots can vary considerably. In the case as shown in FIG. 6, when one slot accommodates more than one extension from different end flaps, the width of the slot can be configured to be the total length of the extensions inserted therein side by side. Preferably, each extension is located at least partially above the hand hole when the fold-over leaf is folded over the end flaps in spaced parallelism to the other leaf. More preferably, as shown for assembled end element 620b in FIG. 6, each extension (617a′ and 617b′) is located completely above the hand hole 650 when the fold-over leaf is folded over the end flaps in spaced parallelism to the other leaf. Because each of the end flaps to which extensions 617a′ and 617b′ are connected have a cut out that is in registration with the hand hole 650 along the edge of the hand hole 650 when end element 620b is assembled, any upward force exerted on the upper edge of hand hole 650, when a hand is inserted into the hand hole to lift the container, is also applied to those end flaps. Having the extensions 617a′ and 617b′ above hand hole 650 ensures that extensions 617a′ and 617b′ are pushed upward when the container is being lifted, further securing the extensions 617a′ and 617b′ in place in slot 625b.

An advantage to having the slots and the extensions at or close to the center of the edge of an assembled end element is the long length of cardboard in the fold of the end element outside of the extensions. The sides are frequently being pushed outward by the contents of the letter tray during use, and the extended length of cardboard resists outward movement of the extensions and reduces the likelihood of tearing.

Notably, the locking tabs of FIG. 6 (624a and 624a′) each have “wings” to the end thereof (shown in FIG. 4B as wings 440a and 440b at the end of locking tab 424a), effectively adding to the width of the end of the unmodified locking tab (shown as 124a in FIG. 4A). This modified configuration can provide additional locking security once the locking tabs are inserted into the slits. The modification is not limited to the structure as shown in FIG. 4B. As long as at least one side of the end of a locking tab goes beyond the respective end of a slit once the locking tab is inserted into the slit in its natural position, so that the locking tab cannot be pulled out of the slit under normal use conditions, the locking tab is considered to be securely engaged in the slit. For example, the width of the end of the locking tabs can slightly exceed the long axis of the slits, so that the locking tabs can be inserted into the slits with relative ease, e.g., by snap fit. Alternatively, the locking tabs may be slightly bent or twisted at their ends for the locking tabs to be inserted into the slits, as long as the slits can allow the insertion of the locking tabs with bent or twisted ends. Once inserted, the locking tabs can assume their shapes prior to the insertion, either automatically upon releasing of the bending or twisting (due to the elasticity of the material used) or manually (by reversing the bending or twisting).

Together, the extensions from the end flaps into the slots of the end elements and the modified locking tabs allow for elimination of the rivets used in prior letter trays, thus reducing cost, easing assembly and improving case of recycling. The rivets prevented outward sliding of the end flaps and lifting of the fold-over leaf, functions now provided by the cardboard extensions and the improved locking tabs.

The ends of the two bottom leaves 619a and 619b meet each other when the two bottom leaves 619a and 619b are folded in spaced parallelism to the bottom of the tray 600, so that the two bottom leaves 619a and 619b together cover the entire bottom of the tray 600, providing essentially another layer to the bottom of the tray. Each bottom leaf has an extension at each side thereof, shown in FIG. 6 as extensions 675a and 675a′ for bottom leaf 619a and extensions 675b and 675b′ for bottom leaf 619b. Each fold-over leaf has a notch cut at the end thereof, shown in FIG. 6 as notch 680a for fold-over leaf 622a and notch 680b for the other fold-over leaf. When tray 600 is assembled, i.e., both bottom leaves are folded in spaced parallelism to the bottom and both fold-over leaves are folded over with the locking tabs at the end thereof inserted into the slits cut along the end element folding lines, the extensions of the bottom leaves cooperate and are inserted into the notches at the end of the fold-over leaf of a corresponding end element. This is shown in FIG. 6 as extensions 675a′ and 675b′ inserted into notch 680b of end element 620b. This locking mechanism helps prevent any vertical movement of the bottom leaves when assembled, so that the bottom leaves are restricted to be in spaced parallelism to the bottom of the container.

The containers according to the embodiment shown in FIG. 6 are sturdier than the containers according to the embodiments shown in FIG. 3, because both the sides and the bottom of the containers according to the embodiment shown in FIG. 6 have more than one layers. The bottom leaves, when assembled and restricted in spaced parallelism to the bottom by the extension/notch structure described above, add essentially another layer to the bottom of the containers. The side elements comprise both outer walls and inner walls, each outer wall and its corresponding inner wall sandwiching two side tabs of opposing end elements. The side tabs can be designed so that two side tabs of the same side meet each other and together cover the entire area sandwiched by an outer leaf and its corresponding inner leaf, adding essentially a third layer to the side. Because of their increased sturdiness, the containers so constructed can have more volume and be used to carry more and/or heavier contents.

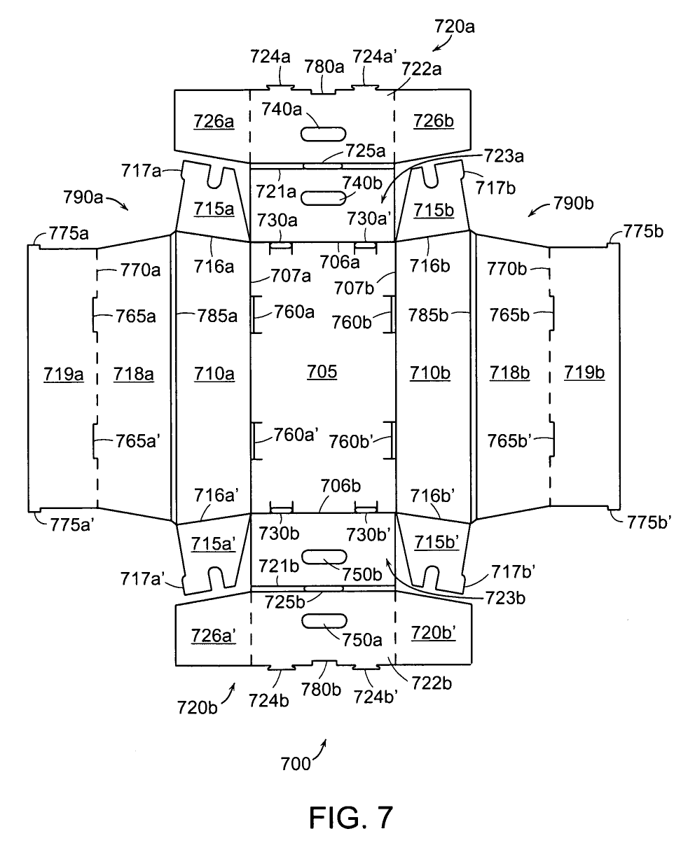

FIG. 7 is a top view of a blank of foldable sheet material constructed to produce a corrugated paper letter tray according to the present invention as shown in FIG. 6. The blank 700 comprises a central wall 705, two side elements 790a and 790b, and two end elements 720a and 720b. The two side elements 790a and 790b each comprise three leaves—an outer leaf (710a and 710b, respectively), an inner leaf (718a and 718b, respectively), and a bottom leaf (719a and 719b, respectively). Each outer leaf is foldable from the central wall 705 along a folding line (707a and 707b, respectively). Each inner leaf is foldable from the corresponding outer leaf along a pair of transverse scores close to each other (each pair shown in FIG. 7 as 785a and 785b for side elements 790a and 790b, respectively). Each bottom leaf is foldable from the corresponding inner leaf along a folding line (shown in FIG. 7 as 770a and 770b for side elements 790a and 790b, respectively). The two end elements 720a and 720b are each foldable from the central wall 705 along a folding line (706a and 706b, respectively). Outer leaf 710a has two end flaps 715a and 715a′, each foldable therefrom along a folding line (716a and 716a′, respectively). Outer leaf 710b has two end flaps 715b and 715b′, each foldable therefrom along a folding line (716b and 716b′, respectively). End element 720a has a pair 721a of parallel transverse scores to define two leaves 722a and 723a and permit one fold-over leaf 722a to fold over end flaps 715a and 715b and in spaced parallelism to the other leaf 723a. End element 720b has a pair 721b of parallel transverse scores to define two leaves 722b and 723b and permit one fold-over leaf 722b to fold over end flaps 715a′ and 715b′ and in spaced parallelism to the other leaf 723b.

A hole 740a is cut in fold-over leaf 722a. A hole 740b is cut in the other leaf 723a. When fold-over leaf 722a is folded over the end flaps 715a and 715b in spaced parallelism to the other leaf 723a, hole 740a and hole 740b together form a hand hole in registration with each other for providing an easy means to lift and carry the container. Similarly, at the other end of the blank, a hole 750a is cut in fold-over leaf 722b. A hole 750b is cut in the other leaf 723b. When fold-over leaf 722b is folded over the end flaps 715a′ and 715b′ in spaced parallelism to the other leaf 723b, hole 750a and hole 750b together form a hand hole in registration with each other for providing an easy means to lift and carry the container.

Two slotted tabs are cut along the folding line connecting the inner leaf and the bottom leaf of a side element, shown in FIG. 7 as 765a and 765a′ for side element 790a and 765b and 765b′ for side element 790b.

Four slits are cut in the central wall 705. Two of them 730a and 730a′ border folding line 706a. The other two 730b and 730b′ border folding line 706b. The long axis of each of the four slits is parallel to the folding line each of them borders, respectively. Fold-over leaf 722a has two locking tabs 724a and 724a′ at its end. Fold-over leaf 722b has two locking tabs 724b and 724b′ at its end. When the fold-over leaf 722a is folded over the end flaps 715a and 715b in spaced parallelism to the other leaf 723a, each of the locking tabs 724a and 724a′ can be inserted into slits 730a and 730a′, respectively. When the fold-over leaf 722b is folded over the end flaps 715a′ and 715b′ in spaced parallelism to the other leaf 723b, each of the locking tabs 724b and 724b′ can be inserted into slits 730b and 730b′, respectively.

Four slots are cut in the central wall 705. Two of them 760a and 760a′ border folding line 707a. The other two 760b and 760b′ border folding line 707b. The long axis of each of the four slots is parallel to the folding line each of them borders, respectively. Slotted tabs 765a, 765a′, 765b and 765b′ can be inserted into slots 760a, 760a′, 760b and 760b′, respectively, when the two inner leaves are folded in spaced parallelism to their corresponding outer leaves, respectively.

A slot 725a is cut in end element 720a. Slot 725a is cut between the pair 721a of scores and borders the scores along its long axis. A slot 725b is cut in end element 720b. Slot 725b is cut between the pair 721b of scores and borders the scores along its long axis. End flaps 715a, 715b, 715a′ and 715b′ each have an extension 717a, 717b, 717a′ and 717b′, respectively. The extensions 717a and 717b can be inserted into slot 725a when fold-over leaf 722a folds over end flaps 715a and 715b in spaced parallelism to the other leaf 723b. The extensions 716a′ and 716b′ can be inserted into slot 725b when fold-over leaf 722b folds over end flaps 715a′ and 715b′ in spaced parallelism to the other leaf 723b.

Each fold-over leaf has two side flaps foldably connected to the sides thereof, shown in FIG. 7 as side flaps 726a and 726b for fold-over leaf 722a and side flaps 726a′ and 726b′ for fold-over leaf 722b, respectively. When a fold-over leaf is folded over in spaced parallelism to the other leaf, a side flap can be inserted into the space between the outer leaf and the inner leaf at the corresponding side, so that when the container is assembled, the side flap is sandwiched between the outer leaf and the inner leaf in spaced parallelism to both the outer leaf and the inner leaf.

Each bottom leaf has two extensions at the sides thereof, shown in FIG. 7 as extensions 775a and 775a′ for bottom leaf 719a and extensions 775b and 775b′ for bottom leaf 719b, respectively. Each fold-over leaf has a notch at the end thereof, shown in FIG. 7 as notch 780a for fold-over leaf 722a and notch 780b for fold-over leaf 722b, respectively. When the container is assembled, i.e., both bottom leaves are folded in spaced parallelism to the bottom and both fold-over leaves are folded over with the locking tabs at the end thereof inserted into the slits cut along the end element folding lines, the extensions of the bottom leaves cooperate and are inserted into the notches at the end of the fold-over leaf of a corresponding end element.

It is noticeable in FIG. 7 that the end of each of the locking tabs 724a, 724a′, 724b and 724b′ is wider than the base of the locking tabs connected to their respective fold-over leaves. FIG. 4B shows a blown-up view of one of these locking tabs to show the “wing” structure in detail.

It is understood that the containers according to the present invention are not limited to the use as letter trays, but can have other uses well known to those skilled in the art. For example, due to the increased sturdiness of the containers according to the embodiment shown in FIG. 6, those containers can have more volume than a letter tray and be used to carry more and/or heavier contents than letters.

The structures for securing containers disclosed herein are not limited to those described in the above embodiments of letter trays, but can be used to secure containers of any form or made of any material, e.g., paper, plastic, and the like, as long as the container has a fold-over structure substantially similar to the one present in the corrugated letter tray previously used by USPS, as described herein. Such fold-over structures are well known to those skilled in the art for producing containers.

For example, the container does not have to have two sides and two ends. The bottom of the container can have any multilateral shape so that the container may have any number of sides. The shape of the sides and/or ends of the container does not have to be trapezoidal as shown in the letter tray embodiments but can assume any shape, e.g., rectangular, as long as it permits the fold-over structure. The fold-over structure (the end element as described above) does not have to be secured by inserting a locking tab connected to the end of the fold-over leaf into a slit cut in the bottom of the container. For example, one or both sides of the fold-over leaf can have a locking tab, each insertable into a slit cut in a side of the container. In this particular embodiment, the slits are preferably cut along the folding line along which the end flaps are folded from the sides. This particular embodiment can save the board used to construct the container, because the fold-over leaf according to this particular embodiment does not have to extend all the way to the bottom of the container. However, for the purpose of containing letter mails and other contents during extended use, e.g., in the case of the use by USPS, it is preferable that the fold-over leaf goes all the way down to the bottom of the container and that the locking tabs are located at the end of the fold-over leaf and insertable into slits cut in the central wall of the blank, i.e., the bottom of the container. As discussed above, the sides of the letter tray are frequently being pushed outward by the content of the letter tray during use, increasing the likelihood of wear and tear between a slot cut in the side and a locking tab inserted therein, as opposed to a slot cut in the bottom of the container, which is at a much more fixed position to secure the locking tabs. In addition, having the fold-over leaf going all the way down to the bottom of the container can effectively add to the durability of the end elements by providing a complete layer of end wall, as opposed to a partial layer. According to the letter tray embodiment of the present invention, the end flaps each have a cut out that is in alignment with the upper edge of the hand hole. If the fold-over leaf does not go all the way down to the bottom of the container but only slightly past the hand hole, then the end of an assembled container below the end of the fold-over leaf is left with only one layer of wall, i.e., that provided by the other leaf, while the end above the hand hole has three layers of walls, i.e., those provided by the fold-over leaf, the other leaf, and the end flaps. This may affect the container's structural integrity during extended use to hold heavy contents.

Those skilled in the art will recognize that the slits and slots described herein are typically straight, narrow cuts or openings. However, they are not limited to such structures, but can be apertures of any shape, as long as the locking tabs described herein can be inserted into the slits, the extensions described herein can be inserted into the slots, and the lateral movements of the extensions in one or both directions along the long axis of the slots (preferably the outward direction with respect to the container) can be prevented.

According to another embodiment of the present invention, one or more surfaces of the container of the present invention can be coated with a moisture-resistant material or sealant to enhance the structural integrity of the container and make the container effectively moisture-resistant. This is especially desirable for the corrugated letter trays, as it can add to the durability during extended use, particularly in humid conditions. It should be noted that the letter trays are expected to be used extensively over months. Even if the conditions of use do not have high humidity, the humidity accumulated over the extended use may compromise the structural integrity of the letter tray without the moisture-resistant coating. The moisture-resistant coating can be used alone or in combination with the improved structure described herein to increase the durability of the letter tray. Preferably, the moisture-resistant material or sealant is repulpable. An example of a moisture-resistant and repulpable sealant is a substance sold under the trademark PROTECOAT 3003 by NuCoat, LLC of Minneapolis, Minn. The moisture-resistant material or sealant can preferably have one or more additional characteristics in connection with the intended use of a container coated with the moisture-resistant material or sealant. These characteristics may include, but are not limited to, skid-resistance and printability (e.g., compatibility with water-based inks). An example of a suitable moisture-resistant and repulpable sealant having both characteristics is a substance sold under the trademark VAPORCOAT 340 by Michelman, Inc. of Cincinnati, Ohio. Although repulpability is a desirable attribute of one container embodiment, those skilled in the art will recognize that other moisture-resistant coatings, which are less amenable to repulping, could be used without departing from the scope of the present invention.

According to another embodiment of the present invention, the container of the present invention is made at least partially of recycled paper. Those skilled in the art will recognize that any kind of paper, for example, corrugated paper, cardboard, or paper made of virgin fiber, as long as it is suitable for making a container with substantial structural integrity to achieve its function as a container, can be used without departing from the scope of the present invention.

While this invention has been particularly shown and described with references to example embodiments thereof, it will be understood by those skilled in the art that various changes in form and details may be made therein without departing from the scope of the invention encompassed by the appended claims.

What is claimed is:

1. A container produced from a blank comprising a central wall, sides and end elements foldable therefrom, said sides having end flaps foldable therefrom, said end elements having one or more transverse scores to define two leaves and permit one fold-over leaf to fold over said end flaps and in spaced parallelism to the other leaf, said fold-over leaf having one or more locking tabs at the end thereof, each insertable into a slit cut in said blank when said fold-over leaf is folded over said end flaps in spaced parallelism to said other leaf, said container having holes cut through both said fold-over leaf and said other leaf, said holes in alignment with each other forming a hand hole when said fold-over leaf is folded over said end flaps in spaced parallelism to said other leaf, said end flaps having cut outs that are in alignment with said hand hole at least along the upper edge of said hand hole when said fold-over leaf is folded over said end flaps in spaced parallelism to said other leaf, wherein the improvement comprises:
for a given end element, a slot cut in the end element near or bordering one or more transverse scores of the end element and parallel to the one or more transverse scores along its long axis; and
an extension on one of the end flaps insertable into the slot when the fold-over leaf of the given end element is folded over said one of the end flaps, the slot preventing lateral movement of the extension inserted therein in an outward direction with respect to the container along the long axis of the slot, the extension being located at least partially above the hand hole when the fold-over leaf is folded over the end flaps in spaced parallelism to the other leaf.

2. The container of claim 1, wherein the blank is made of corrugated paper.

3. The container of claim 2, wherein the paper is recyclable.

4. The container of claim 2, wherein the paper is coated with moisture-resistant coating.

5. The container of claim 4, wherein the moisture-resistant coating is repulpable.

6. The container of claim 1, wherein two or more extensions are inserted into one slot.

7. The container of claim 1, wherein the improvement further comprises:
for a given locking tab inserted in a given slit, an outer edge of the locking tab extending beyond the corresponding end of the slit to secure the locking tab once inserted into the slit.

8. A container produced from a blank comprising a central wall, sides and end elements foldable therefrom, said sides having end flaps foldable therefrom, said end elements having one or more transverse scores to define two leaves and permit one fold-over leaf to fold over said end flaps and in spaced parallelism to the other leaf, said fold-over leaf having one or more locking tabs at the end thereof, each insertable into a slit cut in said central wall when said fold-over leaf is folded over said end flaps in spaced parallelism to said other leaf, said container having holes cut through both said fold-over leaf and said other leaf, said holes in alignment with each other forming a hand hole when said fold-over leaf is folded over said end flaps in spaced parallelism to said other leaf, said end flaps having cut outs that are in alignment with said hand hole at least along the upper edge of said hand hole when said fold-over leaf is folded over said end flaps in spaced parallelism to said other leaf, wherein the improvement comprises:
for a given locking tab inserted in a given slit, an outer edge of the locking tab extending beyond the corresponding end of the slit to secure the locking tab once inserted into the slit.

9. The container of claim 8, wherein said given locking tab is snap inserted into said given slit.

10. The container of claim 8, wherein said given locking tab is inserted into said given slit by slightly bending or twisting said given locking tab.

11. The container of claim 8, wherein the blank is made of corrugated paper.

12. The container of claim 11, wherein the paper is recyclable.

13. The container of claim 11, wherein the paper is coated with moisture-resistant coating.

14. The container of claim 13, wherein the moisture-resistant coating is repulpable.

15. A container produced from a blank comprising a central wall, sides and end elements foldable therefrom, said sides having end flaps foldable therefrom, said end elements having one or more transverse scores to define two leaves and permit one fold-over leaf to fold over said end flaps and in spaced parallelism to the other leaf, said fold-over leaf having one or more locking tabs at the end thereof, each insertable into a slit cut in said central wall when said fold-over leaf is folded over said end flaps in spaced parallelism to said other leaf, said container having holes cut through both said fold-over leaf and said other leaf, said holes in alignment with each other forming a hand hole when said fold-over leaf is folded over said end flaps in spaced parallelism to said other leaf, said end flaps having cut outs that are in alignment with said hand hole at least along the upper edge of said hand hole when said fold-over leaf is folded over said end flaps in spaced parallelism to said other leaf, wherein the improvement comprises:
for a given end element, a slot cut in the end element near or bordering one or more transverse scores of the end element and parallel to the one or more transverse scores along its long axis;
an extension on one of the end flaps insertable into the slot when the fold-over leaf of the given end element is folded over said one of the end flaps, the slot preventing lateral movement of the extension inserted therein in an outward direction with respect to the container along the long axis of the slot, the extension being located at least partially above the hand hole when the fold-over leaf is folded over the end flaps in spaced parallelism to the other leaf, and
for a given locking tab inserted in a given slit, an outer edge of the locking tab extending beyond the corresponding end of the slit to secure the locking tab once inserted into the slit.

16. The container of claim 15, wherein said given locking tab is snap inserted into said given slit.

17. The container of claim 15, wherein said given locking tab is inserted into said given slit by slightly bending or twisting said given locking tab.

18. The container of claim 15, wherein the blank is made of corrugated paper.

19. The container of claim 18, wherein the paper is recyclable.

20. The container of claim 18, wherein the paper is coated with moisture-resistant coating.

21. The container of claim 20, wherein the moisture-resistant coating is repulpable.

22. The container of claim 15, wherein two or more extensions are inserted into one slot.
